(19) United States
(12) Patent Application Publication
(10) Pub. No.: US 2024/0380490 A1
(43) Pub. Date: Nov. 14, 2024

(54) OPTICAL MODULE AND CONTROLLING DEVICE

(71) Applicants: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(72) Inventor: Yuki TUDA, Kawasaki Kanagawa (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 18/781,205

(22) Filed: Jul. 23, 2024

Related U.S. Application Data
(63) Continuation of application No. PCT/JP2022/044647, filed on Dec. 5, 2022.

(30) Foreign Application Priority Data
Mar. 16, 2022 (JP) 2022-041617

(51) Int. Cl. H04B 10/40; H04B 10/073

(52) U.S. Cl. CPC H04B 10/40; H04B 10/073

(57) ABSTRACT

An optical module according to the present embodiment includes a photoelectric element and a gain adjusting unit. The photoelectric element performs at least one of conversion from an electrical signal to an optical signal or conversion from an optical signal to an electrical signal. The gain adjusting unit adjusts a gain of a signal level of at least one of an electrical signal or an optical signal that are output from the photoelectric element in a test of the optical module.

### TECHNICAL FIELD

Embodiments according to the present invention relate to an optical module and a controlling device.

### BACKGROUND ART

Due to a long maintenance period for a controller product such as a controlling device, it is often the case that components used therein reach the end of their lifetimes and need to be replaced. Furthermore, affected by a use environment and the like, degradation of characteristics may occur more prematurely than an expected lifetime. Continuous use without noticing the degradation of characteristics potentially leads to an unintended operation state and results in an unexpected failure.

For example, an optical module having a shorter lifetime than the service life of a controller product is used as a connection module in some cases. Output power of the optical module decreases over time. As a guideline for replacing the optical module, for example, it is a practice to take output power measurements after 10 years. Taking power measurements accompanies work such as preparation of a dedicated measuring device and system reconfiguration, which makes maintenance effort laborious. It is desirable to achieve diagnosis of characteristic degradation of the optical module with less effort.

### CITATION LIST

### Patent Literature

[Patent Literature 1] Japanese Patent Laid-Open No. 2018-37811

### SUMMARY OF INVENTION

### Technical Problem

An objective is to provide an optical module and a controlling device that are capable of performing signal gain adjustment.

### Solution to Problem

An optical module according to the present embodiment includes a photoelectric element and a gain adjusting unit. The photoelectric element performs at least one of conversion from an electrical signal to an optical signal or conversion from an optical signal to an electrical signal. The gain adjusting unit adjusts a gain of a signal level of at least one of an electrical signal or an optical signal that are output from the photoelectric element in a test of the optical module.

### BRIEF DESCRIPTION OF DRAWINGS

FIG. 1 is a block diagram illustrating an exemplary configuration of a controlling system and an operating device according to a first embodiment.

FIG. 2 is a block diagram illustrating an exemplary configuration of optical communication modules according to the first embodiment.

FIG. 3 is a block diagram illustrating an exemplary configuration of an optical module according to the first embodiment.

FIG. 4A is a diagram illustrating exemplary connection among optical communication modules according to the first embodiment.

FIG. 4B is a diagram illustrating exemplary connection among the optical communication modules according to the first embodiment.

FIG. 5 is a block diagram illustrating exemplary results of a degradation diagnosis test of optical modules according to the first embodiment.

FIG. 6 is a flowchart illustrating an exemplary degradation diagnosis test method for optical modules according to the first embodiment.

FIG. 7 is a diagram illustrating exemplary connection of an optical communication module according to a comparative example.

### DESCRIPTION OF EMBODIMENTS

Embodiments according to the present invention will be described below with reference to the accompanying drawings. The embodiments do not limit the present invention. The drawings are schematic or conceptual, and the ratio of parts and the like are not necessarily identical to those in reality. In the specification and the drawings, any element same as in an already described drawing is denoted by the same reference sign and detailed description thereof is omitted as appropriate.

### First Embodiment

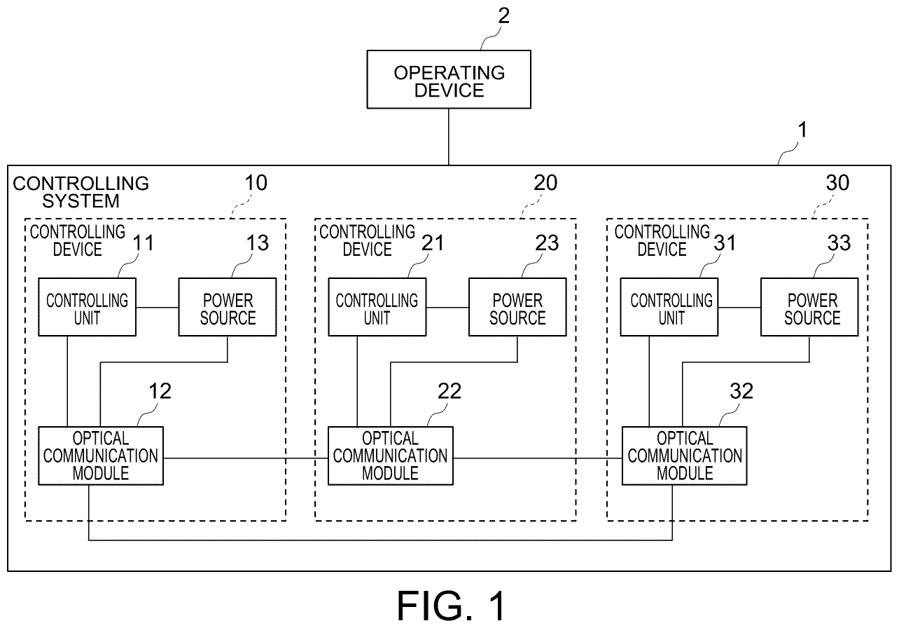

FIG. 1 is a block diagram illustrating an exemplary configuration of a controlling system 1 and an operating device 2 according to a first embodiment.

The controlling system 1 includes a plurality of controlling devices. The following description will be made with a case where the controlling system 1 includes three controlling devices 10, 20, and 30. However, the number of controlling devices only needs to be at least two as described later.

The controlling devices 10, 20, and 30 are connected in a loop.

The operating device 2 receives an input from a user so that the controlling system 1 can be operated. The operating device 2 is, for example, a personal computer (PC) on which a computer program (tool) necessary for operation of the controlling system 1 is installed.

The internal configuration of the controlling device 10 will be described next.

The controlling device 10 includes a controlling unit 11, an optical communication module 12, and a power source 13.

The controlling unit 11 controls a control target instrument (not illustrated).

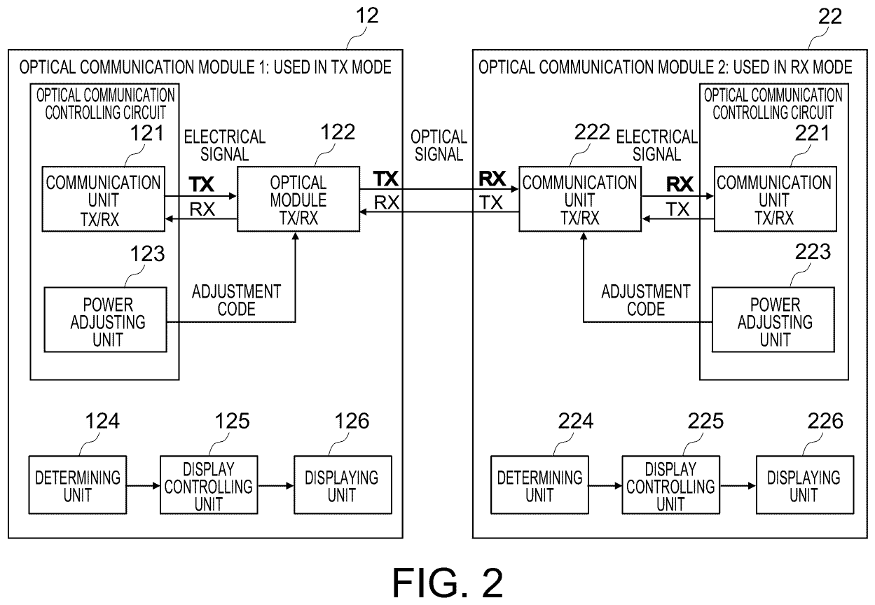

The optical communication module 12 connects the controlling device 10 to the other controlling devices 20 and 30 and performs communication. Note that the optical communication module 12 will be described later in detail with reference to FIG. 2.

The power source 13 supplies electrical power to the controlling unit 11 and the optical communication module 12.

The internal configurations of the controlling devices 20 and 30 will be described next.

The controlling device 20 includes a controlling unit 21, an optical communication module 22, and a power source 23. The controlling device 30 includes a controlling unit 31, an optical communication module 32, and a power source 33.

The configurations of the controlling units 21 and 31 are substantially the same as the configuration of the controlling unit 11, and thus detailed description thereof is omitted. The configurations of the optical communication modules 22 and 32 are substantially the same as the configuration of the optical communication module 12, and thus detailed description thereof is omitted. The configurations of the power sources 23 and 33 are substantially the same as the configuration of the power source 13, and thus detailed description thereof is omitted.

The configurations of the optical communication modules 12, 22, and 32 will be described next.

FIG. 2 is a block diagram illustrating an exemplary configuration of the optical communication modules 12 and 22 according to the first embodiment. Note that the optical communication module 32 is omitted in FIG. 2.

The optical communication module 12 includes a communication unit 121, an optical module 122, a power adjusting unit 123, a determining unit 124, a display controlling unit 125, and a displaying unit 126. Note that the communication unit 121 and the power adjusting unit 123 are provided in an optical communication controlling circuit.

The communication unit 121 transmits an electrical signal to the optical module 122 or receives an electrical signal from the optical module 122.

The optical module 122 converts an electrical signal into an optical signal or converts an optical signal into an electrical signal. Accordingly, optical signals are used for signal transmission between the optical communication modules 12 and 22. Optical signals have less noise than electrical signals and thus are used in long-distance communication.

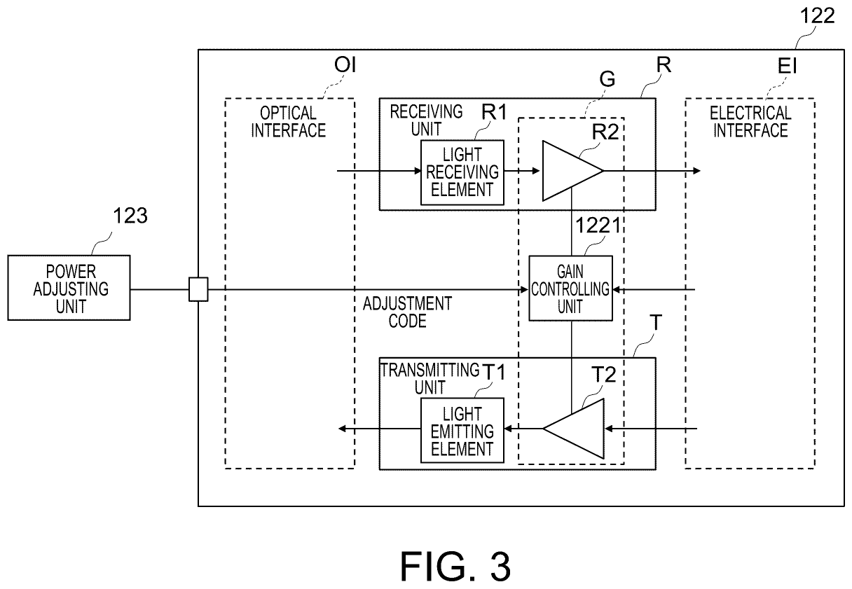

Note that the configuration of the optical module 122 will be described later in detail with reference to FIG. 3.

The power adjusting unit (adjustment information generating unit) 123 generates an adjustment code and outputs the adjustment code to the optical module 122. The power adjusting unit 123 generates the adjustment code in a degradation diagnosis test (degradation test mode) of the optical module 122. Note that the power adjusting unit 123 does not generate the adjustment code in a normal operation mode.

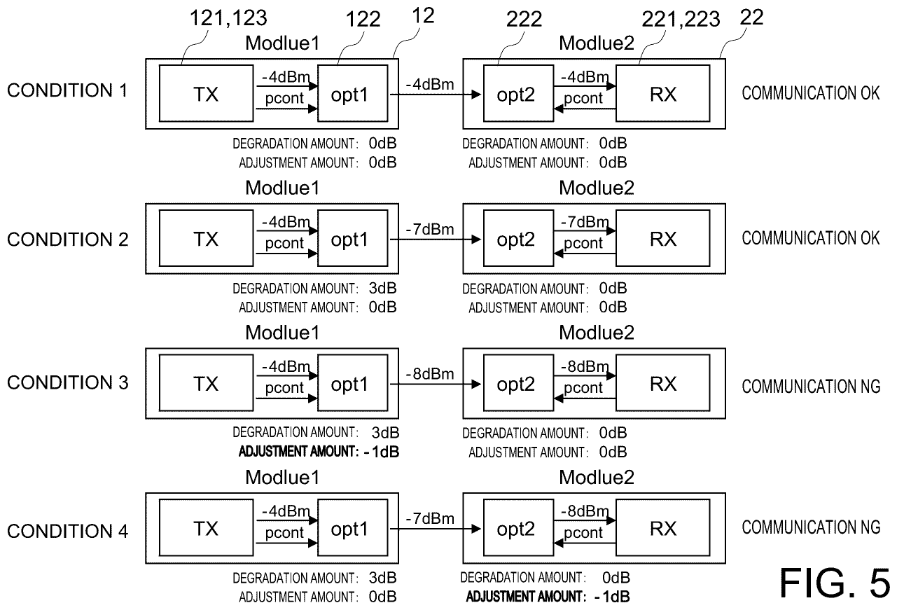

Note that the degradation diagnosis test of an optical module by gain adjustment using the adjustment code will be described later with reference to FIG. 5.

The determining unit 124 determines the state (communication state) of the optical modules 122 and 222 based on an electrical signal input to the communication unit 121, in other words, the signal level of an electrical signal output through the optical modules 122 and 222. The determining unit 124 determines whether the optical modules 122 and 222 are in a communicable state. More specifically, the determining unit 124 determines the state of the optical modules 122 and 222 based on comparison between the signal level of an electrical signal output through the optical modules 122 and 222 and a predetermined signal level.

In the degradation test mode, determination of the communication state by the determining unit 124 operating in the same manner as in the normal operation mode is used. Specifically, in the degradation diagnosis test of the optical module 122, the determining unit 124 determines the state of the optical modules based on the signal level of an electrical signal output through the optical modules 122 and 222 to which the adjustment code is input.

The display controlling unit 125 causes the displaying unit 126 to display a result of the determination by the determining unit 124.

The displaying unit 126 displays the result of the determination by the determining unit 124, in other words, the connection state of the optical modules 122 and 222. The displaying unit 126 is, for example, a light emitting diode (LED). For example, the LED is turned on when communication through the optical module 122 is normally performed, and is turned off when communication through the optical module 122 is not normally performed.

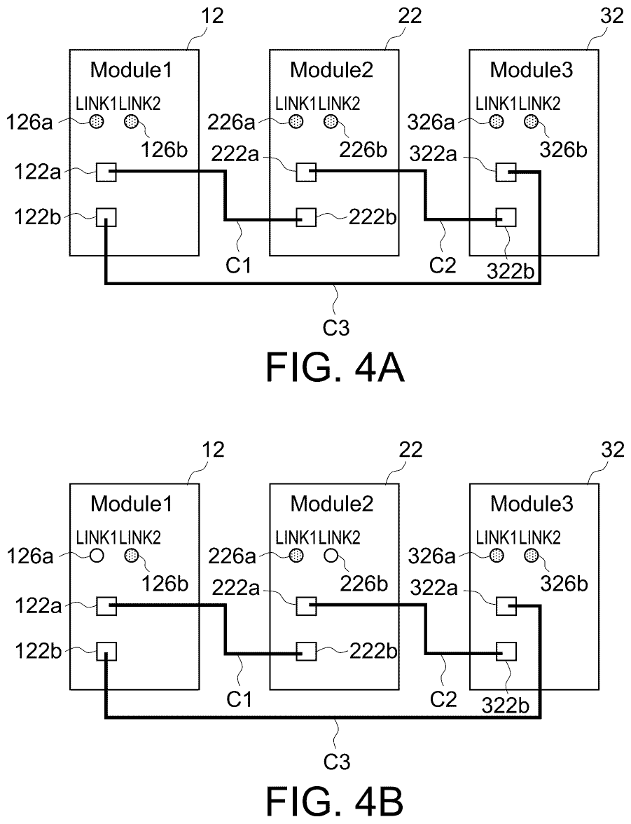

Note that display by the displaying unit 126 will be described later in detail with reference to FIGS. 4A and 4B.

The optical communication module 22 includes a communication unit 221, an optical module 222, a power adjusting unit 223, a determining unit 224, a display controlling unit 225, and a displaying unit 226. Note that the communication unit 221 and the power adjusting unit 223 are provided in an optical communication controlling circuit. As described above, the configuration of the optical communication module 22 is substantially the same as the configuration of the optical communication module 12.

The optical communication modules 12 and 22 operate in a transmission (TX) mode and a reception (RX) mode. When the optical communication module 12 operates in the transmission mode, the optical communication module 22 operates in the reception mode. When the optical communication module 12 operates in the reception mode, the optical communication module 22 operates in the transmission mode. In the optical communication module 12 in the transmission mode, the communication unit 121 transmits an electrical signal to the optical module 122, and the optical module 122 transmits an optical signal to the optical module 222. In the optical communication module 22 in the reception mode, the optical module 222 receives an optical signal from the optical module 122, and the communication unit 221 receives an electrical signal from the optical module 222.

The configuration of each optical module will be described next in detail with the optical module 122 as an example.

FIG. 3 is a block diagram illustrating an exemplary configuration of the optical module 122 according to the first embodiment.

The optical module 122 performs signal conversion between an optical interface OI and an electrical interface EI. The optical interface OI is, for example, an optical fiber. Note that, in the example of the optical module 122 illustrated in FIG. 3, the positional relation between the optical interface OI and the electrical interface EI is inverted in the right-left direction as compared to the optical module 122 illustrated in FIG. 2.

The optical module 122 includes a receiving unit R, a transmitting unit T, and a gain controlling unit 1221.

The receiving unit R receives an optical signal from the optical interface OI, converts the optical signal into an electrical signal, and transmits the electrical signal to the electrical interface EI. The receiving unit R includes a light receiving element R1 and an amplifier R2.

The light receiving element R1 converts an optical signal into an electrical signal. The light receiving element R1 is, for example, a photodiode.

The amplifier R2 amplifies the signal level of an electrical signal converted from an optical signal and output from the light receiving element R1.

The transmitting unit T receives an electrical signal from the electrical interface EI, converts the electrical signal into an optical signal, and transmits the optical signal to the optical interface OI. The transmitting unit T includes a light emitting element T1 and an amplifier T2.

The light emitting element T1 converts an electrical signal into an optical signal. The light emitting element T1 is, for example, a semiconductor laser or a light emitting diode.

The amplifier T2 amplifies the signal level of an electrical signal input to the light emitting element T1 so as to be converted into an optical signal. The signal level of the optical signal changes in accordance with the signal level of the electrical signal. Thus, by changing the signal level of an electrical signal input to the light emitting element T1, the amplifier T2 can change the signal level of an optical signal to be output from the light emitting element T1.

Note that the light receiving element R1 and the light emitting element T1 may also be collectively called a photoelectric element.

The gain controlling unit 1221 controls the gains of the amplifiers R2 and T2. Note that the gain controlling unit 1221 may include a storing unit that stores information necessary for gain control of the amplifiers R2 and T2.

The receiving unit R, the transmitting unit T, and the gain controlling unit 1221 may also be called a gain adjusting unit G. The gain adjusting unit G adjusts the gain of the signal level of at least one of an electrical signal or an optical signal that are output from the photoelectric element in the degradation diagnosis test of the optical module 122.

The gain adjusting unit G acquires the adjustment code related to a gain adjustment amount. More specifically, the gain controlling unit 1221 acquires the adjustment code (gain adjustment information) with which the gains of the amplifiers R2 and T2 can be adjusted in the degradation diagnosis test of the optical module 122.

The gain adjusting unit G adjusts the gain of the signal level of at least one of an electrical signal or an optical signal that are output from the photoelectric element based on the adjustment code related to the gain adjustment amount of the gain adjusting unit G. More specifically, the gain controlling unit 1221 controls the gains of the amplifiers R2 and T2 based on the adjustment code in the degradation diagnosis test of the optical module 122.

The gain adjusting unit G decreases the gain of the signal level of at least one of an electrical signal or an optical signal that are output from the photoelectric element in the test of the optical module 122. The adjustment code is information for decreasing the gains of the amplifiers R2 and T2. Accordingly, the gain adjusting unit G (gain controlling unit 1221) can set the optical module 122 to a degraded state artificially.

The degradation diagnosis test is performed by the determining units 124 and 224 determining the state of communication using the optical modules 122 and 222 set to degraded states artificially.

Exemplary display by the displaying unit 126 and exemplary connection among the optical communication modules 12, 22, and 32 will be described next.

FIGS. 4A and 4B are each a diagram illustrating exemplary connection among the optical communication modules 12, 22, and 32 according to the first embodiment.

FIGS. 4A and 4B illustrate examples in which the three optical communication modules 12, 22, and 32 are connected in a loop as illustrated in FIG. 1.

FIG. 4A corresponds to a case where communication between the optical communication modules 12 and 22 is in a normal state. FIG. 4B corresponds to a case where communication between the optical communication modules 12 and 22 is in an anomalous state, in other words, a case where communication error has occurred.

The optical communication module 12 (Module1) includes two optical modules 122a (CN1) and 122b (CN2) and two displaying units 126a (Link1) and 126b (Link2). The optical communication module 22 (Module2) includes two optical modules 222a (CN1) and 222b (CN2) and two displaying units 226a (Link1) and 226b (Link2). The optical communication module 32 (Module3) includes two optical modules 322a (CN1) and 322b (CN2) and two displaying units 326a (Link1) and 326b (Link2).

The optical communication modules 12 and 22 are connected to each other through a cable C1. The optical communication modules 22 and 32 are connected to each other through a cable C2. The optical communication modules 32 and 12 are connected to each other through a cable C3. The cables C1, C2, and C3 are, for example, optical fiber cables. The cable C1 connects the optical modules 122a and 222b. The cable C2 connects the optical modules 222a and 322b. The cable C3 connects the optical modules 322a and 122b.

The displaying units 126a and 126b each display the communication state of the optical modules 122a and 122b. The displaying units 226a and 226b each display the communication state of the optical modules 222a and 222b. The displaying units 326a and 326b each display the communication state of the optical modules 322a and 322b.

In the example illustrated in FIG. 4A, communication between the optical communication modules 12 and 22 is in a normal state as described above. The signal level of an electrical signal output from the optical module 122a is equal to or higher than the predetermined signal level. The LED of the displaying unit 126a illuminates in, for example, green. Similarly, the signal level of an electrical signal output from the optical module 222b is equal to or higher than the predetermined signal level. The LED of the displaying unit 226b illuminates in, for example, green.

In the example illustrated in FIG. 4B, communication between the optical communication modules 12 and 22 is in an anomalous state as described above. The signal level of an electrical signal output from the optical module 122a is lower than the predetermined signal level. The LED of the displaying unit 126a is turned off. Similarly, an electrical signal output from the optical module 222b is lower than the predetermined signal level. The LED of the displaying unit 226b is turned off.

A method of the degradation diagnosis test of the optical modules 122 and 222 by gain adjustment using the adjustment code will be described next.

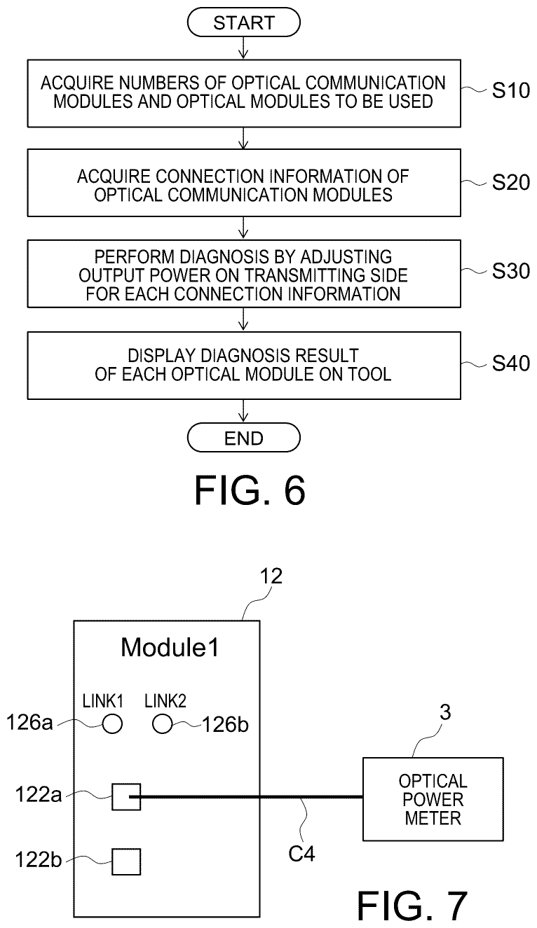

As described later with reference to FIG. 6, the degradation diagnosis test is performed by, for example, switching from the normal operation mode to the degradation test mode in software by using the operating device 2 illustrated in FIG. 1. The adjustment code generated by the power adjusting unit 123 illustrated in FIG. 2 is used in the degradation test mode. Note that cable connection switching, attachment of any other device, and the like are not performed at the switching between the normal operation mode and the degradation test mode.

FIG. 5 is a block diagram illustrating exemplary results of the degradation diagnosis test of the optical modules 122 and 222 according to the first embodiment. FIG. 5 corresponds to an example in which the optical communication module 12 is in the transmission (TX) mode and the optical communication module 22 is in the reception (RX) mode. FIG. 5 presents determination results under Conditions 1 to 4.

In the example illustrated in FIG. 5, the communication unit 121 has a default signal level of −4 dBm. The determining unit 224 determines that the communication state is anomalous in a case where the signal level of an electrical signal output from the optical module 222 (electrical signal input to the communication unit 221) is equal to or lower than −8 dBm.

In FIG. 5, “pcont” represents the adjustment code related to an adjustment amount of the signal level. The state of the optical modules 122 and 222 is determined based on the signal level of an electrical signal output through an optical module (at least one of the optical modules 122 or 123) to which the adjustment code is input.

Under Condition 1, the optical modules 122 and 222 have hardly degraded yet. No gain adjustment is performed.

Under Condition 1, the degradation amount of the optical module 122 is 0 dB, and the adjustment amount of the optical module 122 is 0 dB. Thus, the optical module 122 outputs an optical signal of −4 dBm.

Under Condition 1, the degradation amount of the optical module 222 is 0 dB, and the adjustment amount of the optical module 222 is 0 dB. Thus, the optical module 222 outputs an electrical signal of −4 dBm.

The determining unit 224 under Condition 1 determines that the communication state of the optical module 222 is normal because the signal level of an electrical signal output from the optical module 222, which is −4 dBm, is higher than a predetermined signal level (for example, −8 dBm). Accordingly, the displaying unit 226b is turned on as illustrated in FIG. 4A.

Under Condition 2, degradation of the optical module 122 has progressed as compared to Condition 1. No gain adjustment is performed.

Under Condition 2, the degradation amount of the optical module 122 is 3 dB, and the adjustment amount of the optical module 122 is 0 dB. Thus, the optical module 122 outputs an optical signal of −7 dBm. Under Condition 2, the degradation amount of the optical module 222 is 0 dB, and the adjustment amount of the optical module 222 is 0 dB. Thus, the optical module 222 outputs an electrical signal of −7 dBm.

The determining unit 224 under Condition 2 determines that the communication state of the optical module 222 is normal because the signal level of an electrical signal output from the optical module 222, which is −7 dBm, is higher than a predetermined signal level (for example, −8 dBm). Accordingly, the displaying unit 226b is turned on as illustrated in FIG. 4A.

Under Condition 3, gain adjustment of the optical module 122 is performed unlike under Condition 2.

Under Condition 3, the degradation amount of the optical module 122 is 3 dB, and the adjustment amount of the optical module 122 is −1 dB. Thus, the optical module 122 outputs an optical signal of −8 dBm. Under Condition 3, the degradation amount of the optical module 222 is 0 dB, and the adjustment amount of the optical module 222 is 0 dB. Thus, the optical module 222 outputs an electrical signal of −8 dBm.

The determining unit 224 under Condition 3 determines that the communication state of the optical module 222 is anomalous because the signal level of an electrical signal output from the optical module 222, which is −8 dBm, is equal to a predetermined signal level (for example, −8 dBm). Accordingly, the displaying unit 226b is turned off as illustrated in FIG. 4B.

Under Condition 4, gain adjustment of the optical module 222 is performed unlike under Condition 2.

Under Condition 4, the degradation amount of the optical module 122 is 3 dB, and the adjustment amount of the optical module 122 is 0 dB. Thus, the optical module 122 outputs an optical signal of −7 dBm.

Under Condition 4, the degradation amount of the optical module 222 is 0 dB, and the adjustment amount of the optical module 222 is −1 dB. Thus, the optical module 222 outputs an electrical signal of −8 dBm.

The determining unit 224 under Condition 4 determines that the communication state of the optical module 222 is anomalous because the signal level of an electrical signal output from the optical module 222, which is −8 dBm, is equal to a predetermined signal level (for example, −8 dBm). Accordingly, the displaying unit 226b is turned off as illustrated in FIG. 4B.

Comparison between Conditions 3 and 4 indicates that gain adjustment of either of the optical modules 122 and 222 may be performed.

Comparison of Condition 2 with Conditions 3 and 4 indicates that the sum of the degradation amounts of the optical modules 122 and 222 is changed from 3 dB to 4 dB artificially by gain adjustment. When the sum of the degradation amounts of the optical modules 122 and 222 further increases by 1 dB from the state illustrated in Condition 2, the actual optical modules 122 and 222 lose communication capability. For example, the optical modules 122 and 222 need to be replaced in a case where the sum of the degradation amounts of the optical modules 122 and 222 potentially increases by 1 dBm or more by the next degradation diagnosis test.

The power adjusting units 123 and 223 generate the adjustment code related to an adjustment amount (gain adjustment amount) in accordance with the time interval of degradation diagnosis tests. For example, in a case where the time interval of degradation diagnosis tests is two years and outputs from the optical modules 122 and 222 do not decrease by 1 dB or more in two years, the power adjusting units 123 and 223 generate the adjustment code with an adjustment amount of −1 dB. Accordingly, the optical modules 122 and 222 determined to be normal in the degradation diagnosis test are compensated with an operational period margin of two years.

The process of the degradation test mode for optical modules will be described next.

FIG. 6 is a flowchart illustrating an exemplary degradation diagnosis test method for optical modules according to the first embodiment.

A computer program for the degradation test mode for optical modules is installed on the operating device 2 in advance in addition to the computer program (tool) of the controlling system 1, which is necessary for the normal operation mode. The optical modules 122, 222, 322, and the like used in the controlling system 1 are registered to the tool of the controlling system 1 in advance. The user performs mode switching by, for example, operating the operating device 2 to select the degradation test mode through the tool of the controlling system 1. First, the operating device 2 acquires the number of optical communication and optical modules to be used from setting information of the tool (S10). In the examples illustrated in FIGS. 4A and 4B, the number of optical communication modules 12, 22, and 32 to be used is three. The operating device 2 calculates the number of optical modules that need to be diagnosed based on the number of optical communication modules to be used. Since each optical communication module is provided with two optical modules, the number of optical modules 122a, 122b, 222a, 222b, 322a, and 322b to be diagnosed is six.

Subsequently, the operating device 2 acquires connection information of optical communication modules from the setting information of the tool (S20). The connection information includes information of optical communication modules at the connection source and destination. In the examples illustrated in FIGS. 4A and 4B, the optical module 122a is connected to the optical module 222b (Diagnosis 1). The optical module 122b is connected to the optical module 322a (Diagnosis 2). The optical module 222a is connected to the optical module 322b (Diagnosis 3). The optical module 222b is connected to the optical module 122a (Diagnosis 4). The optical module 322a is connected to the optical module 122b (Diagnosis 5). The optical module 322b is connected to the optical module 222a (Diagnosis 6).

Subsequently, communication units, power adjusting units, and determining units perform diagnosis by adjusting output power on the transmitting side for the connection information of each of Diagnose 1 to 6 described above (S30). In Diagnosis 1, the optical module 122a at the connection source is set to the transmission (TX) mode, and the optical module 222b at the connection destination is set to the reception (RX) mode. The power adjusting unit on the transmitting side generates the adjustment code to adjust output power of the optical module 122a. The communication units on the transmitting and receiving sides perform communication with their output power adjusted. The determining unit on the receiving side determines the communication state of the optical module 222b. In a case where it is determined that the communication state is normal, the operating device 2 records the diagnosis result of the optical module 222b as normal in a log. In a case where it is determined that the communication state is anomalous, the operating device 2 records the diagnosis result of the optical module 222b as anomalous in a log.

Diagnose 2 to 6 are performed in the same manner as Diagnosis 1. Note that the relation between the transmission mode and the reception mode in Diagnosis 1 is inverted in Diagnosis 4. Specifically, in Diagnosis 4, the optical module 222b at the connection source is set to the transmission mode, and the optical module 122a at the connection destination is set to the reception mode.

Note that, at step S30, output power on the receiving side may be adjusted as illustrated in Condition 4 in FIG. 5.

Subsequently, the operating device 2 displays a diagnosis result of each optical module on a screen of the tool (S40). Accordingly, the degradation diagnosis test ends.

As described above, according to the first embodiment, each optical module includes the gain adjusting unit G configured to adjust the gain of the signal level of at least one of an electrical signal or an optical signal that are output from the photoelectric element (at least one of the light receiving element R1 or the light emitting element T1) in the degradation diagnosis test of the optical module. Accordingly, signal gain adjustment can be performed in the degradation diagnosis test.

A power adjusting unit generates the adjustment code related to the gain adjustment amount of the gain adjusting unit G in the degradation test mode. A determining unit determines the communication state of the optical module based on the signal level of an electrical signal output through the optical module. When an input-output power control function is provided as a function to diagnose the optical module, it is possible to set the optical module to a characteristic degraded state artificially (virtually). As a result, it is possible to diagnose characteristic degradation of the optical module and determine whether to replace the optical module.

The power adjusting unit generates the adjustment code to be input to the optical module in a state in which the optical module is connected to another controlling device. In other words, the degradation test mode is established with the same connection setup as in the normal operation mode.

In the first embodiment, the controlling system 1 includes three controlling devices. However, the controlling system 1 may include two controlling devices or may include four or more controlling devices. The four or more controlling devices are connected in a loop as in the examples illustrated in FIGS. 4A and 4B. The degradation diagnosis test is performed for every connection between two optical communication modules.

A comparative example in which the degradation diagnosis test is performed by using an optical power meter 3 will be described next.

FIG. 7 is a diagram illustrating an exemplary configuration according to the comparative example.

The optical power meter 3 is connected to the optical module 122a through a cable C4 and measures output power of the optical module 122a. Whether to replace the optical module 122a is determined based on a result of the measurement by the optical power meter 3. For example, determination in the degradation diagnosis test is performed based on comparison of the measurement result with a value having a margin relative to power with which communication is anomalous.

However, when the optical power meter 3 is connected, it is needed to attach and detach the cables C1 and C4, which are connected to the optical module 122 when the degradation diagnosis test is performed. This potentially results in increase in work time of cable insertion-removal or the like and occurrence of configuration change error. Further, a dedicated measuring device for the degradation diagnosis test needs to be prepared. Furthermore, in a case where anomaly is determined in the degradation diagnosis test, it is difficult to check when characteristic degradation started. For example, in a case where it is determined that the optical module 122 is anomalous, the timing of characteristic degradation in the past potentially causes a problem even if communication is possible.

However, in the first embodiment, degradation of the optical module 122 can be diagnosed by mode switching with the same configuration as in the normal operation mode. The mode switching is performed by using, for example, the operating device 2. Accordingly, it is possible to avoid work of changing the configuration of the cables C1 and C4, other measuring devices, and the like for the degradation diagnosis test. Moreover, in a case where an operational period margin can be known, it is possible to plan replacement of the optical module 122 so that the optical module 122 can be operated in an operational period margin in which characteristic degradation is unlikely to occur.

### Second Embodiment

The adjustment code generated by the power adjusting unit 123 in the first embodiment is different in a second embodiment.

The power adjusting unit 123 generates, for the one optical module 122, a plurality of adjustment codes among which the adjustment amount is different. The gain adjusting unit G performs adjustment so that, for example, the gain of the signal level is swept until anomaly of the communication state is determined by the determining unit 124. Accordingly, an operation output margin of the optical module 122 can be checked.

As in the second embodiment, different adjustment codes may be generated by the power adjusting unit 123. The optical modules 122 and 222, 322 and the controlling devices 10, 20, and 30 according to the second embodiment can achieve the same effects as in the first embodiment.

At least part of the degradation diagnosis test method for an optical module according to the present embodiment may be implemented by hardware or software. When implemented by software, a computer program that realizes at least part of the function of the degradation diagnosis test method may be stored in a recording medium such as a flexible disk or a CD-ROM and read and executed by a computer. The recording medium is not limited to a detachable medium such as a magnetic disk or an optical disk but may be a fixed recording medium such as a hard disk device or a memory. The computer program that realizes at least part of the function of the degradation diagnosis test method may be distributed through a communication line (including wireless communication) such as the Internet. Moreover, the computer program may be encrypted, modulated, or compressed and then may be distributed through a wired or wireless line such as the Internet or by storage in a recording medium.

The embodiments of the present invention are described above but the embodiments are presented as examples and not intended to limit the scope of the invention. The embodiments may be performed in other various forms and provided with various kinds of omission, replacement, and change without departing from the gist of the invention. The embodiments and any modification are included in the scope and gist of the invention and also included in the invention written in the claims and equivalents thereof.

1. An optical module comprising:
a photoelectric element configured to perform at least one of conversion from an electrical signal to an optical signal or conversion from an optical signal to an electrical signal; and
a gain adjusting unit configured to adjust a gain of a signal level of at least one of an electrical signal or an optical signal that are output from the photoelectric element in a test of the optical module.

2. The optical module according to claim 1, wherein the gain adjusting unit includes
an amplifier configured to amplify a signal level of at least one of an electrical signal input to the photoelectric element so as to be converted into an optical signal or an electrical signal converted from an optical signal and output from the photoelectric element, and
an amplifier controlling unit configured to control a gain of the amplifier.

3. The optical module according to claim 1, wherein the gain adjusting unit acquires gain adjustment information related to a gain adjustment amount of the gain adjusting unit and adjusts a gain of a signal level of at least one of an electrical signal or an optical signal that are output from the photoelectric element based on the gain adjustment information.

4. The optical module according to claim 2, wherein the gain adjusting unit acquires gain adjustment information related to a gain adjustment amount of the gain adjusting unit and adjusts a gain of a signal level of at least one of an electrical signal or an optical signal that are output from the photoelectric element based on the gain adjustment information.

5. The optical module according to claim 1, wherein the gain adjusting unit decreases a gain of a signal level of at least one of an electrical signal or an optical signal that are output from the photoelectric element in a test of the optical module.

6. The optical module according to claim 2, wherein the gain adjusting unit decreases a gain of a signal level of at least one of an electrical signal or an optical signal that are output from the photoelectric element in a test of the optical module.

7. The optical module according to claim 3, wherein the gain adjusting unit decreases a gain of a signal level of at least one of an electrical signal or an optical signal that are output from the photoelectric element in a test of the optical module.

8. The optical module according to claim 4, wherein the gain adjusting unit decreases a gain of a signal level of at least one of an electrical signal or an optical signal that are output from the photoelectric element in a test of the optical module.

9. A controlling device comprising:
an optical module including a photoelectric element and a gain adjusting unit, the photoelectric element being configured to perform at least one of conversion from an electrical signal to an optical signal or conversion from an optical signal to an electrical signal, the gain adjusting unit being configured to adjust a gain of a signal level of at least one of an electrical signal or an optical signal that are output from the photoelectric element in a test of the optical module;
an adjustment information generating unit configured to generate gain adjustment information related to a gain adjustment amount of the gain adjusting unit; and
a determining unit configured to determine a state of the optical module based on a signal level of an electrical signal output through the optical module.

10. The controlling device according to claim 9, wherein the adjustment information generating unit generates the gain adjustment information to be input to the optical module in a state in which the optical module is connected to another controlling device.

11. The controlling device according to claim 9, wherein the adjustment information generating unit generates the gain adjustment information related to the gain adjustment amount in accordance with a time interval of tests of the optical module.

12. The controlling device according to claim 10, wherein the adjustment information generating unit generates the gain adjustment information related to the gain adjustment amount in accordance with a time interval of tests of the optical module.

13. The controlling device according to claim 9, wherein the adjustment information generating unit generates, for the one optical module, a plurality of pieces of the gain adjustment information among which the gain adjustment amount is different.

14. The controlling device according to claim 10, wherein the adjustment information generating unit generates, for the one optical module, a plurality of pieces of the gain adjustment information among which the gain adjustment amount is different.

15. The controlling device according to claim 9, wherein the determining unit determines the state of the optical module based on comparison between a signal level of an electrical signal output through the optical module and a predetermined signal level.

16. The controlling device according to claim 10, wherein the determining unit determines the state of the optical module based on comparison between a signal level of an electrical signal output through the optical module and a predetermined signal level.

17. The controlling device according to claim 9, further comprising a display controlling unit configured to cause a displaying unit to display a result of the determination by the determining unit.

18. The controlling device according to claim 10, further comprising a display controlling unit configured to cause a displaying unit to display a result of the determination by the determining unit.
